(19) United States
(12) Patent Application Publication
(10) Pub. No.: US 2003/0161063 A1
(43) Pub. Date: Aug. 28, 2003

(54) Storage apparatus and clock control circuit

(75) Inventors: Yasunori Izumiya, Kawasaki (JP); Keiichi Sato, Kawasaki (JP); Sumie Matsubayashi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/197,187

(22) Filed: Jul. 17, 2002

(30) Foreign Application Priority Data
Feb. 28, 2002 (JP) 2002-54981

(51) Int. Cl. G11B 5/09; G11B 15/12

(52) U.S. Cl. 360/51; 360/61

(57) ABSTRACT

A storage apparatus comprises a CPU that provides read/write control of data from/into a magnetic disk, a PLL circuit that generates clock signals having different frequencies, and a selector which selects a clock signal from among the clock signals generated by the PLL circuit according to a control status of the CPU.

### FIELD OF THE INVENTION

The present invention relates to a storage apparatus and a clock control circuit that consumes less power.

### BACKGROUND OF THE INVENTION

FIG. 5 is a block diagram showing a first example of the configuration of a conventional magnetic disk apparatus. An oscillator 10 shown in this figure generates a reference clock signal and supplies the reference clock signal to a phase locked loop (PLL) circuit 11.

The PLL circuit 11 generates clock signals of different frequencies based on the reference clock signal supplied from the oscillator 10. For instance, the PLL circuit 11 generates three clock signals of 20 MHz, 50 MHz and 100 MHz.

A hard disk controller (HDC) 12 operates based on the 50 MHz clock signal supplied from the PLL circuit 11, and executes read/write control and servo control. A static random access memory (SRAM) 13 operates based on the 100 MHz clock signal supplied from the PLL circuit 11. The SRAM 13 is a memory that can be accessed at high speed. A serial port 14 connects to the servo controller 23 and the read channel 27. A central processing unit (CPU) 15 operates based on the 100 MHz clock signal from the PLL circuit 11, and controls the different sections shown in FIG. 5, such as the HDC 12, the SRAM 13, and the serial port 14, of the magnetic disk apparatus.

A disk enclosure 20 houses a magnetic disk 21 and a spindle motor 22. The magnetic disk 21 is a disk type recording medium that stores data magnetically. The spindle motor 22 is driven and controlled by the servo controller 23 and it rotates the magnetic disk 21 at high speed.

A head 24 comprises, although not shown in the figure, a head core and a coil wound round the head core. The head core and the coil have a fine gap therebetween. The head 24 is disposed in the vicinity of the magnetic disk 21. During writing, the head 24 writes data on the magnetic disk 21 using magnetic field generated based on a recording current supplied to the coil. On the other hand, during reading, the head 24 magnetically reproduces the data recorded on the magnetic disk 21.

A voice coil motor 25 moves the head 24 in the radial direction of the magnetic disk 21 via a carriage. The carriage has not been shown in the figure. The servo controller 23 drives and controls spindle motor 22 and voice coil motor 25, and exerts servo control, i.e. positioning, of the head 24 on magnetic disk 21.

A head integrated circuit (IC) 26, although not shown in the figure, comprises a write amplifier and a pre-amplifier. The write amplifier functions in accordance with write data to switch the polarity of a record current to be supplied to the head 24. The pre-amplifier functions to amplify a reproduced signal (read signal) detected by the head 24.

The read channel 27 comprises, although not shown in the figure, a modulation circuit that writes the write data on the magnetic disk 21, a parallel-to-serial conversion circuit that converts the write data to serial data, and a demodulation circuit that reads data from the magnetic disk 21.

As shown in FIG. 6, the CPU 15 is all the time supplied with a clock signal of 10 MHz. The frequency of this signal is fixed. In this state, while the HDC 12 operates, the CPU 15 converts the frequency of the clock signal from 100 MHz to 50 MHz by providing a waiting time. The CPU 15 controls the HDC 12 based on the 50 MHz clock signal. During the operation of SRAM 13, the CPU 15 controls the SRAM 13 by using the clock signal (100 MHz) as supplied from the PLL circuit 11. During the operation of serial port 14, the CPU 15 converts the frequency of the clock signal from 100 MHz to 20 MHz by providing a waiting time, and controls the serial port 14 based on the clock signal (20 MHz).

While the HDC 12, the SRAM 13 and the serial port 14 operate, the CPU 15 is all the time supplied with the 100 MHz clock signal. Therefore, irrespective of the operating state, the power consumption of the CPU 15 remains constant. As shown in FIG. 9, the power consumption is proportional to the frequency of the clock signal. Thus, the higher the clock frequency becomes, the higher the power consumption will be.

FIG. 7 is a block diagram showing a second example of the configuration of a conventional magnetic disk apparatus. An oscillator 30 shown in this figure generates a reference clock signal and supplies the reference clock signal to a PLL circuit 31. The PLL circuit 31 generates a clock signal based on the reference clock signal supplied from the oscillator 30. For instance, the PLL circuit 31 generates a 100 MHz clock signal.

A CPU 32 operates based on the 100 MHz clock signal supplied from the PLL circuit 31. Although not shown in this figure, the magnetic disk apparatus also comprises the HDC circuit, the magnetic disk, the head, the servo controller, and the read channel that are shown in FIG. 5. The CPU 32 controls all the sections of the magnetic disk apparatus.

An interrupt control circuit 33 controls interrupt processing in the CPU 32. The interrupt processing includes a controller interrupt processing and a servo interrupt processing. The controller interrupt is an interrupt that concerns data read/write control processing for a magnetic disk. In the controller interrupt the CPU 32 exerts control using a clock signal of 50 MHz, for example.

On the other hand, the servo interrupt is an interrupt that concerns servo control used to move the head to a predetermined position of the magnetic disk. In the servo interrupt the CPU 32 exerts control using the clock signal of 100 MHz, for example.

As shown in FIG. 8, the CPU 32 is all the time supplied with a 100 MHz clock signal. The frequency of the clock signal is fixed. In this state, when the controller interrupt processing is to be carried out, the CPU 33 converts the frequency of the clock signal from 100 MHz to 50 MHz by providing a waiting time. Then the CPU 33 carries out the controller interrupt processing using the 50 MHz clock signal. When the servo interrupt processing is to be carried out, the CPU 32 executes the servo interrupt processing using the 100 MHz clock signal received from the PLL circuit 31.

Thus, in the conventional magnetic disk apparatus shown in FIG. 5, the CPU 15 is all the time supplied with clock signals of 100 MHz despite the fact that the frequency of the clock signals required to control the objects, namely the HDC 12, the SRAM 13 and the serial port 14, varies from 50 MHz through 100 MHz to 20 MHz, for instance. In order to obtain the required clock frequency, as shown in FIG. 6, the CPU 15 introduces the waiting times and converts the 100 MHz clock frequency to 50 MHz or to 20 MHz. However, there is a disadvantage that there is a wastage of power. As a result, the conventional magnetic disk is rather high in power consumption. As the frequency of clock signals is increasing as the performance of the CPU's is increasing day by day the problem of higher power consumption is becoming prominent.

On the other hand, in the conventional magnetic disk apparatus shown in FIG. 7, the frequency of clock signal needed for interrupt processing (controller interrupt processing and servo interrupt processing) is 50 MHz and 100 MHz as shown in FIG. 8. The CPU 32 converts the 100 MHz clock signal to the 50 MHz clock signal also by introducing the waiting time as shown in FIG. 8. However, there is a disadvantage that there is wastage of power. As a result, such conventional magnetic disk is rather high in power consumption.

### SUMMARY OF THE INVENTION

It is an object of this invention to provide a storage apparatus and a clock control circuit that consumes less power.

The storage apparatus according to one aspect of the present invention comprises a control unit which provides read/write control of data from/into a recording medium, a clock signal generating unit which generates a plurality of clock signals having different frequencies, and a selecting unit which selects a clock signal that is to be supplied to the control unit from among the plurality of clock signals generated by the clock signal generating unit according to a control status of the control unit.

The clock control circuit according to another aspect of the present invention comprises a clock signal receiving unit that receives a plurality of clock signals each with a different frequency, a control signal receiving unit that receives a signal which indicates a control status of a central processing unit, and a selecting unit which selects a clock signal that is to be supplied to the central processing unit from among the plurality of clock signals received by the clock signal receiving unit according to the control status of the central processing unit indicated by the signal received in the control signal receiving unit.

Other objects and features of this invention will become apparent from the following description with reference to the accompanying drawings.

### BRIEF DESCRIPTION OF THE DRAWINGS

FIG. 1 is a block diagram showing the configuration of a first embodiment of the present invention,

FIG. 2 is a diagram explaining the operation of the first embodiment,

FIG. 3 is a block diagram showing the configuration of a second embodiment of the present invention,

FIG. 4 is a diagram explaining the operation of the second embodiment,

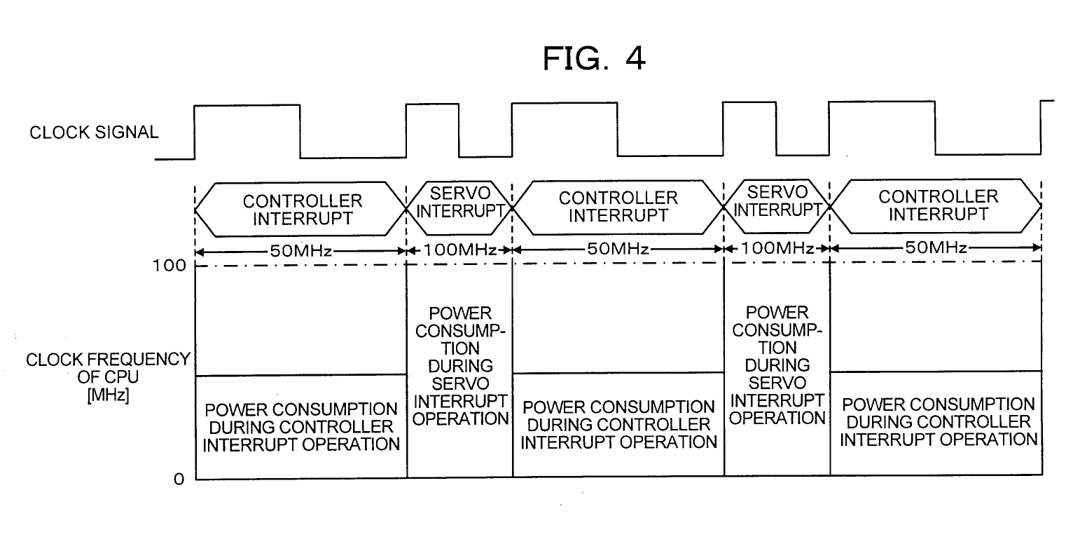

FIG. 5 is a block diagram showing a first example of the configuration of a conventional magnetic disk apparatus,

FIG. 6 is a diagram explaining the operation of the conventional magnetic disk apparatus shown in FIG. 5,

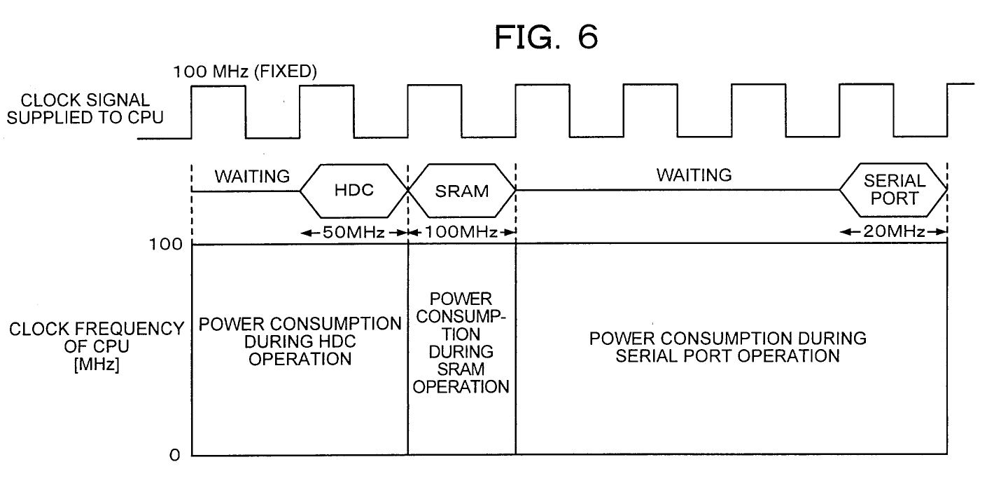

FIG. 7 is a block diagram showing a second example of the configuration of a conventional magnetic disk apparatus,

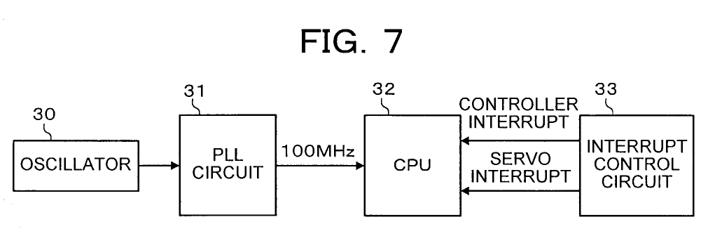

FIG. 8 is a diagram explaining the operation of the conventional magnetic disk apparatus shown in FIG. 7, and

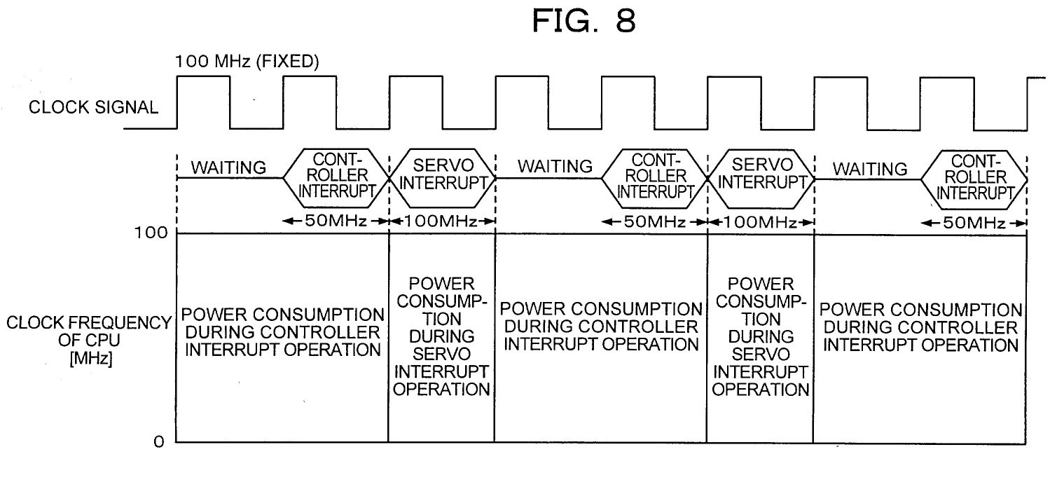

FIG. 9 is a diagram showing the relationship between the frequency of a clock signal and power consumption in a magnetic disk apparatus.

### DETAILED DESCRIPTIONS

Embodiments of the storage apparatus and the clock control circuit according to the present invention will be explained below in detail with reference to the accompanying drawings.

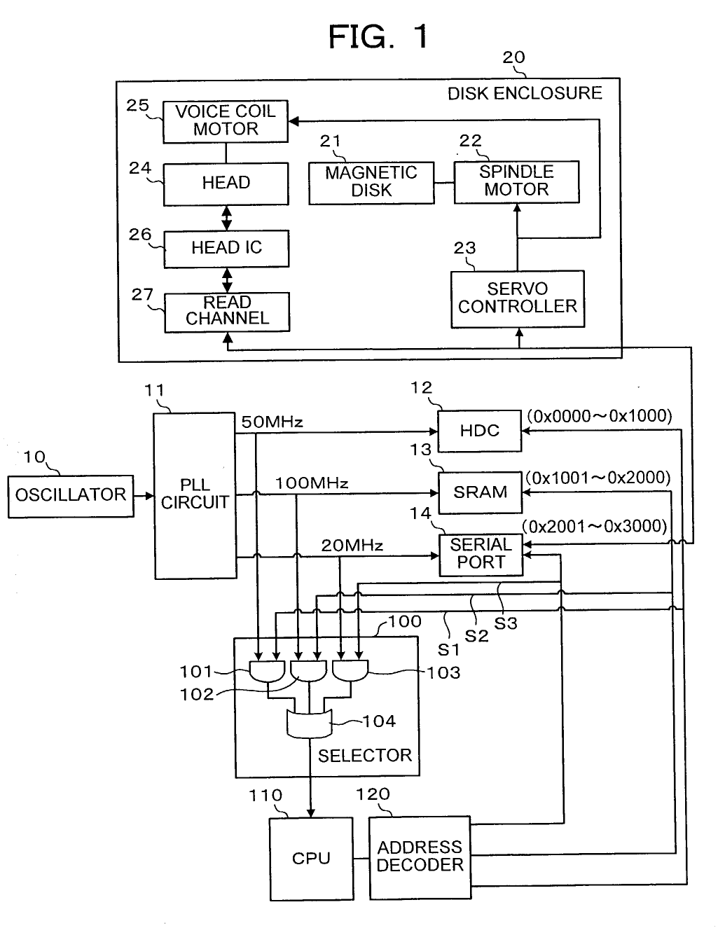

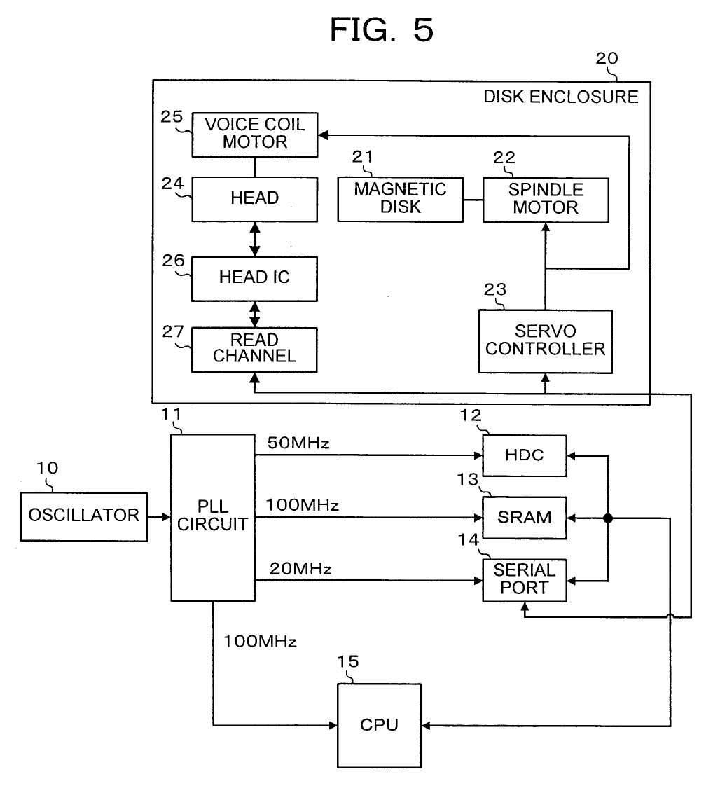

FIG. 1 is a block diagram showing the configuration of a first embodiment of the present invention. Those components in FIG. 1 that perform same or similar function as the components in FIG. 5 have been denoted by same reference numerals and an explanation of these components will be omitted to avoid duplication of explanation.

A selector 100 selects a clock signal of a predetermined frequency from among clock signals respectively of 20 MHz, 50 MHz, and 100 MHz generated by the PLL circuit 11, and supplies the clock signal to a CPU 110.

The 50 MHz clock signal supplied from the PLL circuit 11 is used in the CPU 110 to control the HDC 12 and used for operation in the HDC 12. The 100 MHz clock signal supplied from the PLL circuit 11 is used in the CPU 110 to control the SRAM 13 and used for operation in the SRAM 13. The 20 MHz clock signal supplied from the PLL circuit 11 is used in the CPU 110 to control the serial port 14 and used for operation in the serial port 14.

The selector 100 includes AND circuits 101, 102 and 103, and an OR circuit 104. The 50 MHz clock signal supplied from the PLL circuit 11 and a selection signal S1 corresponding to the HDC 12 supplied from an address decoder 120 explained later are input to the AND circuit 101. The 100 MHz clock signal supplied from the PLL circuit 11 and a selection signal S2 corresponding to the SRAM 13 supplied from the address decoder 120 are input to the AND circuit 102. The 20 MHz clock signal supplied from the PLL circuit 11 and a selection signal S3 corresponding to the serial port 14 supplied from the address decoder 120 are input to the AND circuit 103. The OR circuit 104 performs OR operation with respect to the signals output from the AND circuits 101, 102 and 103.

The CPU 110 operates based on a clock signal of a predetermined frequency (20 MHz, 50 MHz or 100 MHz) selected by the selector 100, and controls respective section, i.e. the HDC 12, the SRAM 13 or the serial port 14.

The HDC 12 is provided with addresses of 0x0000 to 0x1000, for example. The SRAM 13 is provided with addresses of 0x1001 to 0x2000. The serial port 14 is provided with addresses ranging from 0x2001 to 0x3000.

The CPU 110 specifies an object to be controlled by using an address. For example, if the HDC 12 is the object, the CPU 110 specifies an address ranging from 0x0000 to 0x1000. If the SRAM 13 is the object, the CPU 110 specifies an address ranging from 0x1001 to 0x2000. If the serial port 14 is the object, the CPU 110 specifies an address ranging from 0x2001 to 0x3000.

The address decoder 120 decodes the address specified by the CPU 110. The decoded information is information concerning the object to be controlled by the CPU 110 and also represents a state of the CPU 110. The address decoder 120 outputs the decoded information to the AND circuit 101, 102 or 103 as the selection signals S1, S2 or S3.

For example, if the decoded address is in the range from 0x0000 to 0x1000, then the object is the HDC 12, and the selection signal S1 corresponding to the HDC 12 is output from the address decoder 120 to the AND circuit 101. If the decoded address is in the range from 0x1001 to 0x2000, then the object is the SRAM 13, and the selection signal S2 corresponding to the SRAM 13 is output from the address decoder 120 to the AND circuit 102. If the decoded address is in the range from 0x2001 to 0x3000, the object is the serial port 14, and the selection signal S3 corresponding to the serial port 14 is output from the address decoder 120 to the AND circuit 103. For, example, when controlling the HDC 12, the CPU 110 selects an address space from 0x0000 to 0x1000, and therefore, the address decoder 120 outputs the selection signal S1 to the AND circuit 101.

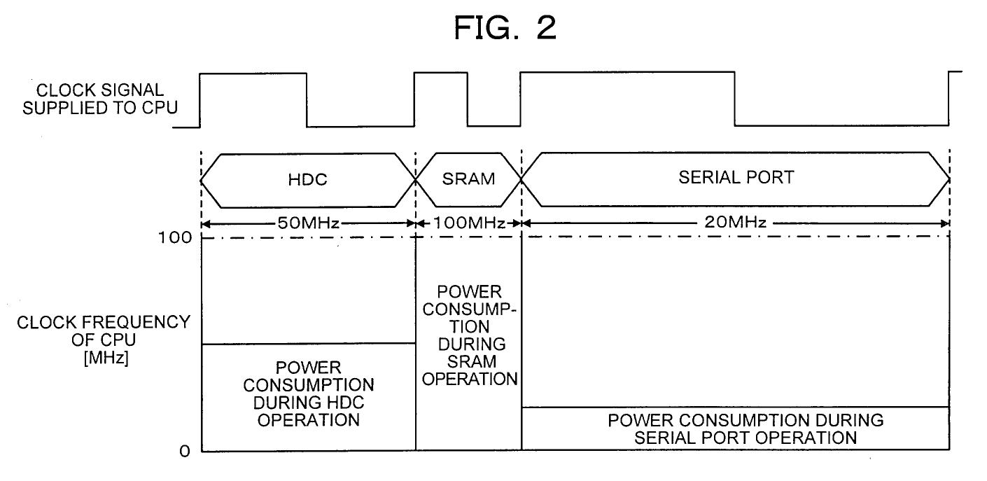

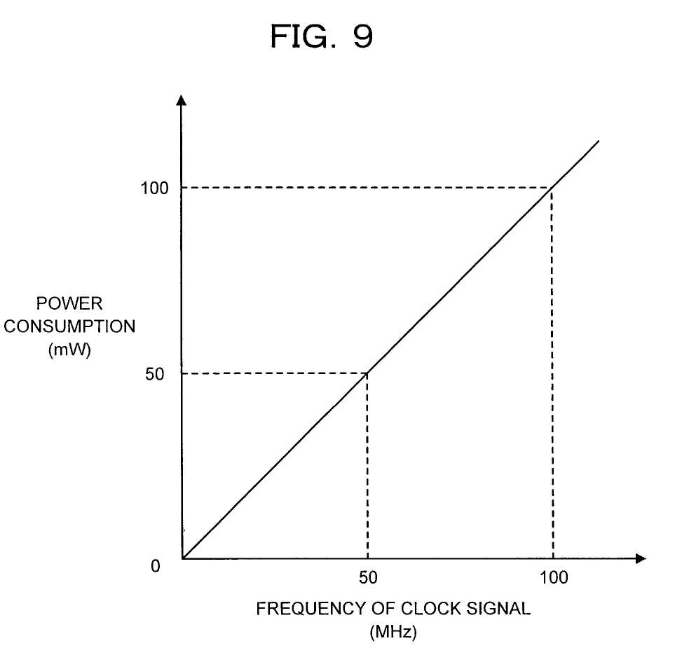

The AND circuit 101 performs an AND operation on the 50 MHz clock signal supplied from the PLL circuit 11 and the selection signal S1. The OR circuit 104 supplies the 50 MHz clock signal to the CPU 110. In this case, the 50 MHz clock signal is selected by the selector 100. As shown in FIG. 2, the CPU 110 controls the HDC 12 based on this 50 MHz clock signal. Because of this lower frequency, in the operation of the HDC 12, the power consumption is reduced to half as compared to the case when the frequency of the clock signal is 100 MHz (see FIG. 9).

Similarly, when controlling the SRAM 13, the CPU 110 specifies an address in the range between 0x1001 and 0x2000, the address decoder 120 decodes the address and outputs the selection signal S2 to the AND circuit 102. Moreover, the AND circuit 102 performs an AND operation on the 100 MHz clock signal supplied from the PLL circuit 11 and the selection signal S2. The OR circuit 104 outputs the 100 MHz clock signal to the CPU 110. In this case, the 100 MHz clock signal is selected by the selector 100. Finally, as shown in FIG. 2, the CPU 110 controls the SRAM 13 based on this 100 MHz clock signal.

Similarly, when controlling the serial port 14, the CPU 110 specifies an address in the range between 0x2001 and 0x3000, the address decoder 120 decodes the address and outputs the selection signal S3 to the AND circuit 103. Moreover, the AND circuit 103 performs an AND operation on the 20 MHz clock signal supplied from the PLL circuit 11 and the selection signal S3. The OR circuit 104 outputs the 20 MHz clock signal to the CPU 110. In this case, the 20 MHz clock signal is selected by the selector 100. Finally, as shown in FIG. 2, the CPU 110 controls the serial port 14 based on this 20 MHz clock signal. In the operation of the serial port 14, since the 20 MHz clock signal is used, the power consumption is reduced to one-fifth as compared to the case when the frequency of the clock signal is 100 MHz.

According to the first embodiment,a frequency of the clock signal to be supplied from the PLL circuit 11 to the CPU 110 is selected from among a plurality of frequencies (20 MHz, 50 MHz and 100 MHz) according to the object to be controlled (the HDC 12, the SRAM 13 or the serial port 14) by the CPU 110. Therefore, waste in power consumption is eliminated and power consumption highly reduced.

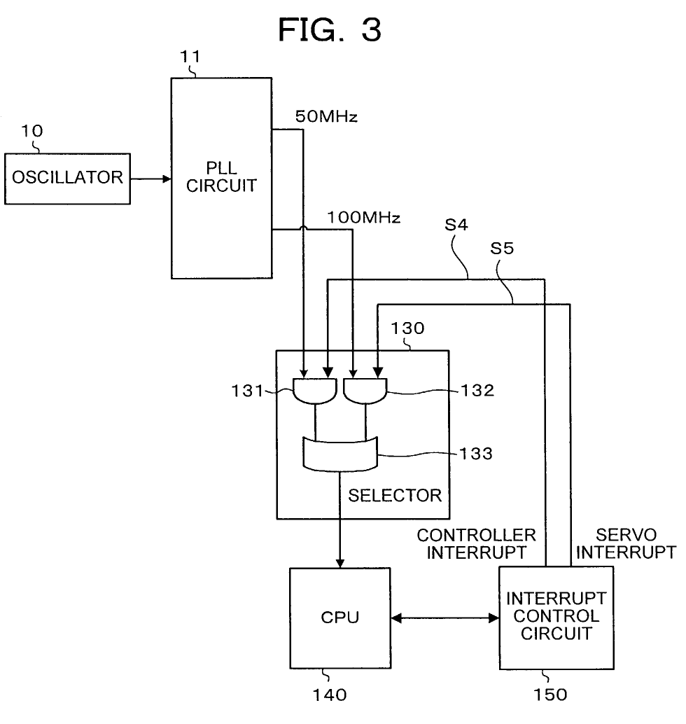

FIG. 3 is a block diagram that shows the configuration of a second embodiment of the present invention. Those components in FIG. 3 that perform same or similar function as the components in FIG. 1 have been denoted by same reference numerals and an explanation of these components will be omitted to avoid duplication of explanation. It should be noted that the HDC circuit, the magnetic disk, the head, the servo controller, and the read channel shown in FIG. 1 have not been shown in FIG. 3 for convenience sake.

A selector 130 selects one of the 50 MHz or 100 MHz clock signals generated by the PLL circuit 11, and supplies the clock signal to a CPU 140. The 50 MHz clock signal supplied from the PLL circuit 11 is used in controller interrupt processing explained later. On the other hand, the 100 MHz clock signal is used in servo interrupt processing explained later.

The selector 130 comprises AND circuits 131 and 132, and an OR circuit 133. The 50 MHz clock signal supplied from the PLL circuit 11 and a selection signal S4 corresponding to the controller interrupt processing are input to the AND circuit 131. The 100 MHz clock signal supplied from the PLL circuit 11 and a selection signal S5 corresponding to the servo interrupt processing are input to the AND circuit 132. The OR circuit 133 performs an OR operation on the signals output from the AND circuits 131 and 132. The CPU 140 operates based on the clock signal selected by the selector 130, and controls respective sections of the magnetic disk apparatus (storage apparatus) according to the second embodiment.

An interrupt control circuit 150 controls interrupt processing conducted in the CPU 140. The interrupt processing may be the controller interrupt processing or the servo interrupt processing. The controller interrupt is an interrupt that concerns read/write control processing of data on the magnetic disk. In this controller interrupt, the CPU 140 exerts control using the clock signal of 50 MHz, for instance. On the other hand, the servo interrupt is an interrupt that concerns servo control conducted to move the head to a predetermined position of the magnetic disk. In this servo interrupt, the CPU 140 exerts control using the clock signal of 100 MHz, for example.

When the controller interrupt is to be carried out, the interrupt control circuit 150 outputs the selection signal S4. The AND circuit 131 performs an AND operation on the 50 MHz clock signal and the selection signal S4. As a result, the OR circuit 133 outputs the 50 MHz clock signal to the CPU 140. This operation corresponds to selection of the 50 MHz clock signal by the selector 130. The CPU 140 executes the controller interrupt processing based on the 50 MHz clock signal. In the controller interrupt processing, the power consumption is reduced to half as compared to the case when the frequency of the clock signal is 100 MHz (see FIG. 9).

When the servo interrupt is to be carried out, the interrupt control circuit 150 outputs the selection signal S5. The AND circuit 132 performs an AND operation on the 100 MHz clock signal and the selection signal S5. As a result, the OR circuit 133 outputs the 100 MHz clock signal to the CPU 140. This operation corresponds to selection of the 100 MHz clock signal by the selector 130. The CPU 140 executes the servo interrupt processing based on the 100 MHz clock signal.

According to the second embodiment, a frequency of the clock signal to be supplied from the PLL circuit 11 to the CPU 140 is selected from among a plurality of frequencies (50 MHz and 100 MHz) according to the interrupt processing (the controller interrupt processing or the servo interrupt processing) to be performed by the CPU 140. Thus, there is reduction in power consumption as compared with the conventional art in which the frequency of the clock signal is fixed.

Two embodiments of the present invention have been explained in detail above with concrete examples of the configuration. However, the configurations are not limited to those mentioned above. Design changes that do not depart from the spirit of the present invention are incorporated in the present invention. For example, it has been explained above that the-frequency of the clock signal supplied to the CPU is selected based on the object to be controlled and the interrupt processing to be performed. However, the frequency may be selected according the number (queues) of instructions that wait for execution in the CPU. For example, a slow clock may be selected when the queue is short. An effect similar to that of the first and second embodiments is obtained with such a configuration. Moreover, the construction of the first embodiment, the second embodiment, and any modification of these embodiments may be combined in various ways.

According to one aspect of the present invention, the frequency at which a clock signal is supplied to a control unit is selected from among the plurality of frequencies according to a control state of the control unit. As a result, there is no wastage of power and thus the power consumption is reduced.

Moreover, the frequency at which a clock signal is supplied to the control unit is selected from among the plurality of frequencies according to the controlled objects of the control unit. Furthermore, the frequency at which a clock signal is supplied to the control unit is selected from among the plurality of frequencies according to which interrupt processing is to be conducted by the control unit. Moreover, the frequency at which a clock signal is supplied to a control unit is selected from among the plurality of frequencies according to the number of instructions waiting to be executed by the control unit. As a result, there is no wastage of power and thus the power consumption is reduced.

According to another aspect of the present invention, the frequency at which a clock signal is supplied to the CPU is selected from among the plurality of frequencies according to the control status of the CPU. Because of this, as compared to conventional method in which the frequency of clock signal is fixed, waste in power consumption is eliminated and power consumption is reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A storage apparatus comprising:
a control unit which provides read/write control of data from/into a recording medium;
a clock signal generating unit which generates a plurality of clock signals having different frequencies; and
a selecting unit which selects a clock signal that is to be supplied to the control unit from among the plurality of clock signals generated by the clock signal generating unit according to a control status of the control unit.

2. The storage apparatus according to claim 1, wherein the selecting unit selects the clock signal according to an object that is to be controlled by the control unit.

3. The storage apparatus according to claim 1, wherein the selecting unit selects the clock signal according to an interrupt processing that is to be carried out by the control unit.

4. The storage apparatus according to claim 1, wherein the selecting unit selects the clock signal according to a number of instructions waiting to be executed by the control unit.

5. A clock control circuit comprising:
a clock signal receiving unit that receives a plurality of clock signals each with a different frequency;
a control signal receiving unit that receives a signal which indicates a control status of a central processing unit; and
a selecting unit which selects a clock signal that is to be supplied to the central processing unit from among the plurality of clock signals received by the clock signal receiving unit according to the control status of central processing unit indicated by the signal received in the control signal receiving unit.
